(19) United States
(12) Patent Application Publication
(10) Pub. No.: US 2007/0005478 A1
(43) Pub. Date: Jan. 4, 2007

(54) Business method for obtaining efficient and low cost financing for business transactions

(76) Inventor: Donald M. Lambe, Chicago, IL (US)

Correspondence Address: GIFFORD, KRASS, GROH, SPRINKLE & CITKOWSKI, P.C, PO BOX 7021, TROY, MI, 48007-7021, US

(21) Appl. No.: 11/471,268

(22) Filed: Jun. 20, 2006

Related U.S. Application Data
(60) Provisional application No. 60/695,509, filed on Jun. 30, 2005.

(51) Int. Cl. G06Q 40/00

(52) U.S. Cl. 705/35

(57) ABSTRACT

The present invention discloses a new and attractive form of security which includes direct ownership of business revenues, and which can also include ownership of defined business assets. These business and investor benefits are derived from asset-based securities in which the underlying assets consist wholly or in part of revenue rights under one or more revenue-sharing agreements. These securities can also be based on a combination of business assets and revenue-sharing agreements.

### CROSS REFERENCE TO RELATED APPLICATIONS

The present application claims the priority of U.S. Provisional Patent Application Ser. No. 60/695,509, filed Jun. 30, 2005 and entitled “Business Method for Obtaining Efficient and Low-Cost Financing for Business Transactions.”

### BACKGROUND OF THE INVENTION

1. Field of the Invention

The invention concerns the use of asset-backed securities for which the backing consists in whole or in part of a revenue sharing agreement or agreements. The agreements further specify a continuing source(s) of revenue, a portion, percent or fractional share of such for which ownership is transferred to owners of securities, for a specified term or period of duration of the agreement.

2. Description of the Prior Art

Although business finance continues to grow in complexity and sophistication, the financing of expansion, growth, modernization and acquisitions is still usually accomplished, apart from use of retained earnings, through borrowing from lines of credit, by selling bonds, by issuing shares of stock, or by combinations of these means. Each of these sources can be useful, but each has limitations and liabilities. Debt financing, through borrowing or the sale of bonds, is nearly always significantly less costly than equity financing. However, debt financing results in higher fixed costs and increased business risk. It also weakens the balance sheet, reduces credit ratings and increases future borrowing costs. Those limitations are particularly evident in an environment of rising interest rates. On the other hand, while issuing additional shares of stock avoids increased debt or fixed costs, it dilutes the equity of existing shareholders and depresses the value and price of stock.

Asset-backed securities based on revenue-sharing agreements offer an attractive alternative which avoids these limitations. They provide a way to raise funds at, or near, the low cost of debt, yet they avoid additional capital obligations, debt or a weakened balance sheet. More specifically, they typically reduce the cost of capital by roughly one half when compared with the composite cost of capital (weighted average cost of combined debt and equity) of most corporations. The history of asset-backed securities based on mortgages, and the relative interest rates they yield, confirm this relationship. These new securities based on revenue-sharing agreements also avoid the dilution of equity and the downward pressure on stock prices caused by issuing additional shares. That is what makes the solutions offered by this invention so attractive. Sale and lease-back arrangements cannot accomplish similar results because such leases must be capitalized under an extensive set of accounting rules and guidelines.

The present structure of business financing also has disadvantages for investors. Neither bondholders nor stockholders independently own a guaranteed portion of business revenues. Instead, before reaching investors, business revenues must first trickle through the corporate books, and can be consumed or diverted in many ways, such as high operating or material costs, excessive executive compensation or perks, golden parachutes, litigation, regulatory fines, retained earnings or cash hoarding, questionable acquisitions, overly conservative contingency reserves or the smoothing of earnings. Media coverage of such instances is a daily occurrence.

This invention places the investor in a stronger and more secure position, more comparable to that of a silent partner in a joint venture. Through the medium of an asset-backed security, wherein the asset backing consists wholly or in part of direct ownership of a defined portion of business revenue, with such ownership secured through a legal revenue-sharing agreement, the investor stands at the head of the line, tapping directly into the flow of business revenues as it is received, before it can be otherwise consumed or diverted. In fact, for the defined portion of revenues for which it has contractually and irrevocably transferred ownership through the revenue-sharing agreement, the related business acts as a collection agent for the investor.

Prior art includes asset-backed securities where “bundled” or pooled mortgages are used to provide the backing for such securities. Such securities are used to liquidate mortgage holdings by commercial firms, including firms which finance mortgage loans and aggregate such mortgages for resale. However, the purpose, structure and function of asset-backed securities based wholly or in part on fractional rights under specialized revenue-sharing agreements are wholly new and novel, as is the use of such agreements to secure and transfer ownership of assets for reduced financing costs, a lower cost structure, reduced fixed costs and reduced capital obligations. The novelty of the financing provided by this invention has been confirmed in discussions held under strict non-disclosure agreements with industry executives. These executives included partners in venture capital firms, investment bankers, vendors of large technology systems, principals in major business consulting firms and principals in leading international accounting firms.

Prior art also includes the use of Special Purpose Entities (SPEs) by banks and other financial institutions for the purpose of receiving, consolidating and temporarily holding assets pursuant to the securitization of these assets. Such use of SPEs is discussed in current annual reports of such firms as Royal Bank of Canada and Lehman Brothers. However, when a business acts as transferor of such assets and the SPE acts as transferee, limitations apply as to the ability to subsequently transfer these assets to such a business. The concern is that this may not be an “arms length” transaction. This invention provides for an investment banker, broker, intermediary or other third party to fill the role of transferee, thus assuring a subsequent “arms length” transaction if contract provisions permit the transfer of assets to the business establishment which is a signatory to the revenue-sharing agreement.

In addition, prior art includes the use of sale, lease-back agreements to remove assets and capital obligations from the books of the original asset owner. However, FASB is scrutinizing these transactions, in addition these arrangements have lost much of their advantage because of accounting rules and regulations whereby they must be capitalized if they exceed $500,000 and meet any of several conditions, including a lease term that includes the useful life of the asset. Such limitations apply because such a lease makes a business liable for a known, specific and continuing stream of payments and because of concerns that some such transactions are not at “arms lengths”. The present invention does not present this problem because of four important differences: 1) the second party or securities holder legally owns the revenues specified in the agreement, and acts more as a silent partner in a joint venture than as a leasing agent, and such revenues are not first booked by the first party, 2) the stream of revenues from the agreement is inherently variable, and does not constitute a known, specific and continuing stream of payments, 3) pursuant to such variability, business risk is transferred from the operating business to the second party or subsequent securities holders, and 4) asset-backed securities purchased in the open market are obviously “arms length” transactions.

Finally, prior art also includes various instruments for hedging financial risk. These instruments vary from insurance policies to short or long positions in the stock market and increasingly varied and complex derivatives. However, no hedging has yet been done through the use of the unique asset-based securities which are a central element of this invention, because no such securities yet exist.

Additional prior art includes a first example of an existing method for creating a multi-level business alliance in non-exclusive geographical areas, as set forth in U.S. Patent Publication Serial No. 2004/0073474, to Field et al., and which teaches a founding firm and at least one foundation firm. The alliance may also include firms at other levels, these members sharing resources, clients and revenue based on a predetermined formula. As such, multiple firms work together to provide a broader range of services to each other's clients while remaining independent of each other, and while permitting the smaller alliance members to have access to the resources of the larger members and vice versa.

U.S. Patent Publication No. 2001/0032117, to Persky, discloses a continuous and updatable revenue sharing process for lists and by which revenues generated from the rental, sale and exchange of lists compiled by “list owners” and used by “list users” are periodically shared with “listed individuals” who provide personal data that appears on the lists. The portions of revenue credited to each of the listed individuals are determined based upon whether a list including the listed individual generated revenue, the quality of data provided (e.g. periodically updated information) and the quantity of data provided (e.g., percentage of questions answered in a questionnaire).

U.S. Patent Publication No. 2006/0059055, to Lin, discloses a business mode/process for conducting business transactions over the Internet, this allowing buyers to reduce the price of the selected product/service based on the buyer's performance during a collateral activity. Sellers offer the product/service within a specified price range, and buyers accept the offer, in exchange for the opportunity to close the transaction at the lowest price offered by achieving a high score or performance rating during the collateral activity. An ultimate price within an agreed upon range is determined based upon the buyer's performance and scaled to the performance of the collateral activity. Changes to the price may occur throughout the performance of any activity (including video games, sports bets, card games and the like) and may be performed against a seller, preprogrammed software opponent, computer opponent, another buyer competing for the same or a different product, a player participating as a player only and not a buyer, or anyone or anything else. The seller receives payment for listing products to sell, and as the products attract buyers to participate in PDAs, the time can turn into advertisement revenues for the host of the web site, and the revenue can be shared accordingly with the sellers.

International Publication No. WO 00/49546, to Priceline.com, teaches a system and method for allocating conditional purchase offers (CPO) among a plurality of agency-based and broadcast-based sellers in a buyer-driven commerce system. In one embodiment, the system determines which agency-based or broadcast based sellers can fulfill or satisfy the CPO and orders those sellers in a priority order. In another embodiment, the priority is also determined by metrics and buyer information or, in a yet further embodiment, determined randomly. The system ensures that when a buyer can satisfy the CPO at multiple price levels, the highest price level fulfills the CPO, thus ensuring maximum seller revenue for each CPO.

WO 2006/014295, to Summer, teaches a peer-to-peer (P2P) business and commerce enhancing method including the steps of (a) identifying an active P2P network which is characterized with peers having a defined affinity interest in the exchange of at least category A information, such as digital music song files, and (b) employing the at least category A information exchange affinity interest as a carrier vehicle and growth engine for the promotion, within that network, of collateral income-generating transactions between a peer and a party who may be inside or outside the network. Of central importance to such a commerce enhancement, or growth, as promoted by practice of the invention, is that such growth is driven by network-internal, peer-group enthusiasm, linked with imaginative peer entrepreneurship in the engaging of peer-to-peer file sharing behavior.

WO 2002/39717, to Aranet, Inc., teaches a method and system for generating revenue using a streaming video that includes primarily informative content for users. An indication of one or more products or services is preferably provided in the informative content of the streaming video. The indication may be a picture of the product or service, or an audio indication, or both as desired. A link is preferably placed in the streaming video that directly or indirectly links a user or viewer to a site that has additional information related to one or more products or services indicated in the streaming video. Revenue may be generated from companies that offer the products or services that are indicated or featured in the streaming video. The service or business that provides the streaming video, the companies that offer the products or services, and/or the web site(s) that distribute the streaming video may receive some or all of the generated revenue, preferably in a revenue sharing arrangement.

U.S. Pat. No. 6,935,948, issued to Wright, teaches a method of multiple pricing for a predetermined single jackpot in a single lottery game. A lottery prize can represent an incremental (multiplying factor) or variable (amount increases with number of tickets sold). In one particular embodiment, a shared multiple pricing lottery game with a single predetermined jackpot is disclosed.

U.S. Pat. No. 5,737,414, to Walker et al., teaches a billing and collection system for enabling payment for a service provided over a data network by billing a customer for a telephone connection to a shared revenue billing network where the telephone connection to the billing network regulates access to the service provided over the data network. A data network includes at least one user on-line service provider presenting at least one user on-line service for on-line access by a user with a user company through the data network, a billing network and an access management computer for controlling access to the on-line service provider and billing the user for access to the on-line service provider. The access management computer communicating with the data network for enabling and terminating access to the on-line service provider through the user computer whereby the billing network shares revenues for the telephone connection with the on-line service provider.

Finally, U.S. Pat. No. 6,546,418, issued to Schena et al., teaches a method for bridging the gap between the virtual multimedia based Internet world and the physical world of tangible object media, such as print media. More particularly, a method for managing a domain name service based on initiating a communication from an object containing provider information using a scanner, a portal server and a receiver connected across a network. The method involves scanning a machine-readable code containing a link information corresponding to the provider information from the object using the scanner and storing the machine-readable code in a memory. The link information is then extracted from the machine readable code in the memory. A user input information corresponding to the provider information is also obtained and stored in the memory. The link information and the user input information are then sent to the portal server via the network. The portal server receives the link information and user input information and selects a multimedia information sequence corresponding to the link information and the user input information. The multimedia information sequence is then sent to the receiver via the network. The receiver receives and stores the multimedia information sequence, plays the sequence automatically or, in response to a stimulus, such as a user request.

### SUMMARY OF INVENTION

This invention provides a new, more efficient and less costly way to finance business expansion, growth, modernization, restructuring and acquisitions, resulting in a sharply lower cost of capital, reduced capital obligations and less debt. As a result, this invention contributes directly to more rapid and more profitable business expansion and modernization than would otherwise be possible.

For investors, this invention provides a new and attractive form of security which includes direct ownership of business revenues, and which can also include ownership of defined business assets. These business and investor benefits are derived from asset-based securities in which the underlying assets consist wholly or in part of revenue rights under one or more revenue-sharing agreements. These securities can also be based on a combination of business assets and revenue-sharing agreements. Specific business and investor benefits of this invention are listed in FIG. 1.

The benefits of this invention also extend to financial institutions, which gain new flexibility and capabilities to meet client needs, and attractive new types of securities to sell to the investing public. Other benefits include new ways to reduce the cost and accelerate the deployment of environmentally friendly technology. The structure, applications and benefits of this invention and the underlying revenue-sharing agreements are described in more detail in subsequent discussion.

The following discussion includes illustrative applications of these specialized asset-backed securities and additional details concerning the structure and processes involved in developing and executing these underlying revenue-sharing agreements and in their securitization.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustrative chart indicating the benefits of the present invention;

FIGS. 2A and 2B illustrate successive flowcharts collectively representing the development of basic revenue sharing agreements with asset transfer;

FIGS. 3A and 3B illustrate successive flowcharts collectively representing a revenue sharing agreement applied to embedded equipment, machinery, systems, or other technology already owned by a first party;

FIGS. 4A and 4B illustrate successive flowcharts collectively representing an example of a revenue sharing agreement applied to a combination of new equipment, machinery, systems or technology being provided by a second party and other assets already owned by a first party;

FIG. 5 is a flowchart illustrating a revenue flow resulting from a revenue sharing agreement;

FIG. 6 is a flowchart illustrating a termination of a revenue sharing agreement due to reaching a cumulative maximum revenue value;

FIG. 7 is a flowchart illustrating a termination of contract due to purchase of rights by first party;

FIG. 8 is a succeeding flowchart illustrating options of a second party;

FIG. 9 is a flowchart of the securitization of a revenue sharing agreement which includes the transfer of ownership to a second party;

FIG. 10 is a successive flowchart for securitizing of revenue sharing agreement, by which a vendor acts as transferor, a special purpose entity (SPE) acting as transferee;

FIG. 11 is a flowchart of for securitizing a revenue sharing agreement for an existing, in-place system, with a factor/investment banker as transferor, a special purpose entity as transferee; and

FIG. 12 is a final flowchart illustration of a revenue sharing agreement with a service provider (SP) retaining title to an in-place system, the SP acting as transferor, the SPE further acting as transferee.

### DETAILED DESCRIPTION OF THE PREFERRED EMBODIMENTS

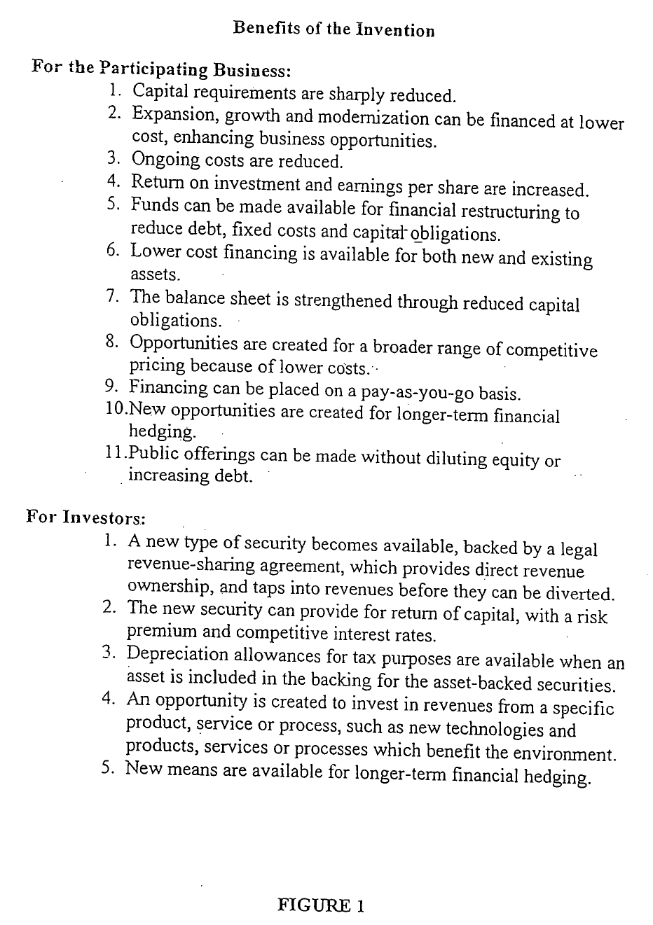

Referring to FIG. 1, a listing of benefits are illustrated of the revenue sharing agreement system and method according to the present invention.

Revenue-sharing agreements are inherently highly flexible. They fit a wide variety of businesses and industries and adapt to a broad range of business problems. They can also be customized for almost any revenue streams. Moreover, nearly any business or corporation can benefit from lower costs of capital, reduced capital obligations and debt, and lower fixed costs. Therefore, the range of applications for this invention is extensive. It includes, but is not limited to, businesses involved in all forms of products and services related to communication, internet access, video, broadband, natural gas, health care, energy, electricity, transportation, raw materials, processing, refining, manufacturing, distribution, chemicals, foods and beverages, pharmaceuticals, metals and minerals, software and entertainment.

Capital-intensive industries and processes offer particularly effective and attractive applications because of the large base of capital to which savings apply. Examples include communications networks, medical technology, nuclear power plants, the emerging generation of more environmentally friendly coal gasification plants, petroleum exploration, extraction and refining (including new technologies in this field), the newer, ultra-pure and ultra-precise pharmaceutical manufacturing facilities, electronic chip manufacturing plants and other highly automated and complex manufacturing and processing operations.

There are many individual applications within this broad market. The six general types of application discussed below have been selected to illustrate the versatility and variety of these applications and the benefits of this invention.

1. Lower-Cost Financing and Lower Cost Structure for Specific, Selected New Products, Services and Processes

This application involves reducing the cost of specific products, services or processes by reducing a major, integral component of their cost structure, specifically the cost of capital. The cost savings involved can be tied directly to individual assets involved in the production, operation or delivery of these products, services and processes by transferring ownership of these assets to investors through asset-backed securities which are backed by both revenue-sharing agreements and ownership rights to such assets. These assets are then owned by the investors in the securities, who act virtually as silent partners in a joint venture, while the operation and administration of the assets is undertaken by the business enterprise. This application provides the ability to target cost reductions to specific competitive products, services or processes because the capital costs of an asset used to provide such services have been reduced. An example would be use of this financing to acquire use of technology to provide competitive broadband internet access. The electronic systems used to increase the capacity of fiber optic networks would meet that qualification. Such service could then be provided with reduced costs and increased pricing flexibility.

This lower cost of financing and the related lower cost structure for specific products, services and processes can be applied to a broad range of machinery, equipment, technology systems, information and communications systems and other business assets.

2. Lower-Cost and Accelerated Deployment of New, Environmentally Friendly Technology, with New Forms of Public Participation

The selection of specific products, services and processes for cost reduction, as described in (1) directly above, can include additional public and corporate benefits when the products, services or processes selected have special public appeal, such as those which provide environmental improvements. An example is the group of “green” products currently being promoted by the General Electric Corporation, including coal gasification plants using technologies which reduce emissions of carbon dioxide, mercury and particulate matter, and locomotives which use environmentally cleaner hybrid diesel technology with improved efficiency and reduced consumption of fossil fuels. Other examples include the emerging generation of large-scale wind farms and solar powered plants.

By financing such coal gasification plants or hybrid diesel locomotives through the use of asset-backed securities, with the backing of such securities including both a) a revenue-sharing agreement related to the revenues generated by these assets, and b) title to those specific assets, both the public and participating corporations would benefit. For the corporation, initial financing costs and ongoing carrying charges would be significantly reduced, permitting accelerated and more profitable deployment of these technologies at reduced risk. An added public relations benefit would be the ability to offer direct participation to the public through subscription to the asset-based securities involved. Through such subscription, the public would have an opportunity to directly own a portion of this impressive new “green technology”, and directly contribute to accelerated deployment and related environmental improvements. In such cases, the ability to invest in specific products, services or processes is a benefit of this invention and construct, as distinguished from stock investments, which necessarily involve total corporate operations.

3. Low-Cost Cash Infusions to Finance Growth, Expansion and Modernization

To gain a cash infusion to finance growth, expansion or modernization, a revenue-sharing agreement transferring ownership of a defined portion of revenue from specified products, services or processes can be used as backing for an asset-based security. When these securities are sold, the participating business enterprise receives the net proceeds. The portion of revenues for which ownership is transferred can be graduated to correspond with the desired amount of the cash infusion and degree of risk transferred. Other factors which can increase the value of such securities are a lengthened term of revenue-sharing and/or the inclusion of asset ownership rights as backing for the securities. An example would be use of such financing to gain a cash infusion for use in financing new technology or machinery for improved productivity.

4. Financial Restructuring

This new form of financing can be used for financial restructuring in several ways, depending upon the magnitude and type of restructuring which is desired. For example, asset-based securities backed by revenue-sharing agreements can be used to generate funds to pay down debt or for stock buy-backs. In addition, selected assets can also be included as backing for these securities. These assets can be new assets, assets provided by a vendor or other third party, assets already owned and operated by the business wishing to undertake financial restructuring or any combination of these sources. Such action can increase the proceeds from the sale of securities and further reduce capital costs and capital obligations. The extent and nature of restructuring desired would dictate the scope and term of the required revenue-sharing agreement, but virtually any such action would improve profitability and bolster credit ratings and share prices.

5. A New Type of Initial Public Offering (IPO)

When a privately held corporation launches an initial public offering of stock, the original owners of the enterprise receive the net proceeds of the offering, but then must share ownership and control with the new shareholders. The net proceeds are a welcome reward for the original owners and/or a source of funds for the corporation, but the loss of sole control and ownership is often viewed as a negative but unavoidable consequence. Sometimes this potential sharing of control is sufficient to discourage the IPO.

The present invention provides a way of issuing an IPO which provides the desired flow of funds to the present owners from the proceeds of the asset-backed securities, but leaves these owners in full ownership and control through continued, exclusive ownership of stock. The IPO in this case is not shares of stock, but new securities backed by a revenue-sharing agreement. Of course, such securities can also be issued if the business concerned is publicly owned. In such cases, present shareowners can also be given preferential subscription rights to such securities so that they can retain proportional ownership rights, if desired.

6. Financial Hedging Arrangements

Asset-based securities backed by revenue-sharing agreements, or by a combination of revenue-sharing agreements and ownership of defined assets, provide excellent instruments for hedging for periods of up to 15 years, or even longer. Applications in the power/energy industry provide specific examples which can be adapted to apply to a much wider range of industries. New or expanded petroleum refining plants can be financed wholly or in part by revenue-sharing agreements. The purchase of asset-backed securities based on these agreements would provide an effective hedge against higher petroleum prices for large consumers of petroleum, because higher income from these securities would help offset higher petroleum prices in the future. For the refineries, the sale of such securities would hedge against lower petroleum prices and reduce the cost of financing new plant. Similarly, the huge new, more environmentally friendly coal gasification plants, which will cost an estimated $2.5 billion each, could be financed wholly or in part through asset-backed securities based on revenue-sharing agreements. For the gasification plants, the use of such financing would reduce capital costs and provide a hedge against future declines in energy prices. For large industrial consumers, the purchase of such securities would provide a hedge against higher prices for energy. Because asset-backed securities based on revenue-sharing agreements and ownership of assets would tend to have a term of about 15 years or longer, or the useful or depreciable life of the asset involved, such hedges could provide valuable protection for extended periods.

Another application within the energy industry involves development of the vast petroleum deposits which reside in shale formations in the western U.S. Canada has been hugely successful in using innovative technologies to extract petroleum from the large tar sand deposits in their western provinces. Current production from this source now runs at a level of approximately one million barrels a day, approximately 80% of which is exported to the United States. Yet to date, development of the shale fields in the U.S. has been negligible or non-existent. This is not a minor matter, given the concern with U.S. dependency on foreign oil, the worrisome U.S. trade deficit, and the positive job creation, economic activity and geopolitical impact which would accompany a large-scale U.S. shale extraction project. Underscoring these factors is the fact that the petroleum reserves in U.S. shale have been estimated by various experts at three trillion barrels, or more than ten times the size of the massive reserves of Saudi Arabia.

The primary reason for the failure to develop this resource is risk. If the world price of oil fell below about $30 per barrel, the estimated cost of shale oil extraction, the vast investment required in this technology would have little value. Yet there are many speculators and industrial consumers of petroleum who would be perfectly willing to assume part of such a risk in return for protection against high oil prices. As a result, this is a classic example of a situation where use of asset-backed securities of the type described above would provide an excellent hedging instrument. For the extraction enterprise, the revenue-sharing agreement would transfer and reduce risks associated with a reduction in the world price of petroleum, while also lowering initial financing costs and ongoing carrying charges associated with the extraction technology and machinery. For the industrial petroleum consumers who purchased the asset-backed securities, which would be based on revenue-sharing rights associated with shale extraction, and further secured by title to related extraction technology and/or machinery, the risk of higher oil prices would then be reduced or offset because of the higher payments they would receive under the revenue-sharing agreement. As a matter of national interest, large-scale development of these shale reserves could ultimately convert the U.S. from a large importer of petroleum to a large exporter, with a corresponding revision in the balance of trade and in the pricing power of OPEC.

Revenue-Sharing Agreements: Structure and Contents

There are two basic structures for revenue-sharing agreements, both of which can be customized for the applications above or a broad variety of other solutions: 1) a structure designed for cases where the asset backing for the asset-based securities includes ownership rights to specified assets in addition to the revenue-sharing agreement and associated stream of revenues, and 2) a structure designed for cases which do not include such asset ownership rights, and where the asset backing for the asset-based securities consists primarily or exclusively of a revenue-sharing agreement and the associated stream of revenues. Both of these basic structures are discussed below, followed by a review of additional terms, conditions and processes available for further customization.

Asset-Based Securities Which Include Asset Ownership Rights

In the first of the two above cases, where asset ownership rights are transferred, the related assets and capital obligations are removed from, or not entered upon, the books of the operational business involved. In this structure, the revenue-sharing agreement includes a first party, consisting of the business which generates the revenue which is to be shared, and which will receive funds from the securitization process, and a second party, which provides financing or acts as a supplier, vendor, broker, factor, investment banker, Special Purpose Entity (SPE), intermediary or partner to the first party, and enables, facilitates, expands, supplements or enhances services, products or process of the first party by providing or financing assets, including but not limited to machinery, equipment, hardware, software, systems or technology to the first party, wherein an effective period of a revenue sharing agreement is specified, and the following provisions, terms and conditions are included in such an agreement:

1) The second party retains title to, and ownership of, the assets provided or other defined assets of the first party for the duration of the revenue-sharing agreement, with the right to liquidate all or part of his or her interest in such assets and revenue sharing agreement by securitizing them or transferring or selling them for Securitization, and

2) Such assets are subject to the exclusive use and control of the first party, and may be located or installed on the premises of the first party, and also may be integrated and combined with assets owned by the first party, and

3) The first party is responsible for the maintenance and operation of the assets provided by the second party, and for the marketing, administrative, billing and collection functions related to the processing, products or services associated with or derived wholly or in part from the assets provided or owned by the second party, including products, services, or processing provided jointly with assets owned by the first party, and

4) The second party is directly assigned full ownership of an agreed portion, or percent, of revenues derived from the products, services or processing referenced in (3), above, or from an otherwise specified group of products, services or processes, and has unqualified, direct and full ownership of such revenues, and

5) At various times during the term of the contract, the agreement may provide that there may be variations in the defined portion or percent of such revenues assigned to the second party, or there may be different products, services or processes subject to revenue sharing to recognize changes in such things as product mix and pricing, and

6) The portion or percent of the revenues defined in (4), above, may be based wholly or in part on the net book or market value of the assets provided by the second party, the net present value of the estimated revenues to be directly assigned to the second party, based on the effective date of the revenue sharing agreement or other agreed date, prevailing and anticipated commercial interest rates, administrative, financing, and securitization costs associated with the revenue sharing contract, including risk factors and the expected market value of the revenue sharing agreement, and

7) The assets to be provided or financed by the second party are clearly specified, together with a stated schedule for their delivery and/or installation, if new, and

8) The revenue-producing products, services or processes to be included in the revenue sharing agreement are specified and estimates of the revenues to be derived from these sources at various intervals within the revenue sharing agreement may be stated, and

9) Maximum revenue values to be received by the second party within any given period may be specified, and

10) Clauses and schedules may be included which provide for adjustments in the portion or percent of revenues directly assigned to the second party when products, services or processes are added or deleted from the revenue sharing agreement by mutual agreement of the parties, or if revenues from the services specified under (8) above vary significantly from stated estimates, and

11) A specified maximum value of revenues assigned to, and received by, the second party during the term of the contract may be defined, after which maximum is reached, the contract may be terminated without penalty by the first party, or may be terminated automatically, and

12) Title to and ownership of the subject assets provided by the second party may pass to the first party at the termination of the contract, and

13) The value of revenues assigned to the second party, when securitized, are generally expected to be appropriate and sufficient to provide a) a return of capital, 2) competitive interest payments, including a risk premium, and

14) Tax deductions for depreciation of the underlying assets will generally accrue to the securities owners while they retain title to those assets.

Asset-Based Securities Which do not Transfer Asset Ownership

In the second of the two basic structures, in which the asset-backing for the securities consists primarily or exclusively of the revenue-sharing agreement and the associated stream of revenues, and does not include ownership rights for specified assets, the structure of the revenue-sharing agreement is simpler. It therefore conforms to the structure of that described above for asset-based securities which include ownership rights for assets, but excludes items 1, 2, 3, 7 and 14 above, which apply to such assets.

Additional Terms, Conditions and Processes for Further Customization

Specific circumstances and business purposes of individual firms wishing to use this new form of financing will necessarily vary. To provide means for customizing revenue-sharing agreements to meet these varied needs, the supplementary or revised terms, conditions and processes discussed below may be used:

1) A provision whereby the first party has an option to purchase the assets and revenue sharing rights of the second party, by assigning additional revenues or making payments to reach the maximum value referenced in (11) above, at one or more times during the term of the contract.

2) An arrangement whereby the asset to be operated and maintained by the first party but owned by the second party, and which may be transferred to another party or securitized, is either presently owned by the first party or provided by a vendor or other third party.

3) Use of a Special Purpose Entity (SPE) within a financial institution to operate, administer or facilitate the securitization process and future administration of the revenue-sharing agreement by providing one or more of the following functions: a) Development and marketing of the related asset-backed securities, b) purchasing the revenue-sharing agreement and any related assets from the original business or from an agreed vendor, broker, investment banker or other third party, c) arranging temporary or bridge financing for the business client pursuant to developing and marketing related asset-backed securities, d) acting as a transferee in a transaction in which the concerned business acts as a transferor of the revenue-sharing agreements prior to securitization, e) acting as a transferee in a transaction in which a vendor, supplier, factor, investment banker, intermediary or other party acts as a transferor of the revenue-sharing agreement or agreements rights and asset titles prior to securitization.

4) Reducing the risk of investors by including a safety margin in the portion or percent of revenues transferred to them, or in the term of the contract, so that they are reasonably assured of a return of capital, an appropriate risk premium and a competitive rate of interest or return on their investment.

5) Reducing the risk of the involved business (first party) by specifying an outside limit, or maximum revenue value to be received by investors in monthly or other periodic payments and/or in total payments during the life of the agreement. In some cases, including those where revenue production may be delayed, such a maximum revenue value can be combined with an open-ended or indefinite duration of revenue-sharing. The term of the agreement and maximum value of revenues to be shared can thus be balanced to achieve the desired level of risk and speculation for both investors and the sponsoring business in any given situation.

6) Specifying more than one group of products, services or processes as the base from which a portion of revenues are to be transferred to investors, or specifying total corporate revenues as such a base, or specifying different sources of revenues to apply at different times of the agreement to accommodate such factors as product, service or technology lifecycles.

7) Using a formula for revenue sharing which would accommodate a transition period during which existing sources of revenues were to be phased out and replaced by other sources of revenues due to new products, services or processes. Such a formula could specify, for example, a) X% of A revenue source or Y% of B revenue source, whichever is larger, but not to exceed $(stated sum), or b) X% of A revenue source or Y% of total revenues, but not to exceed $(stated sum).

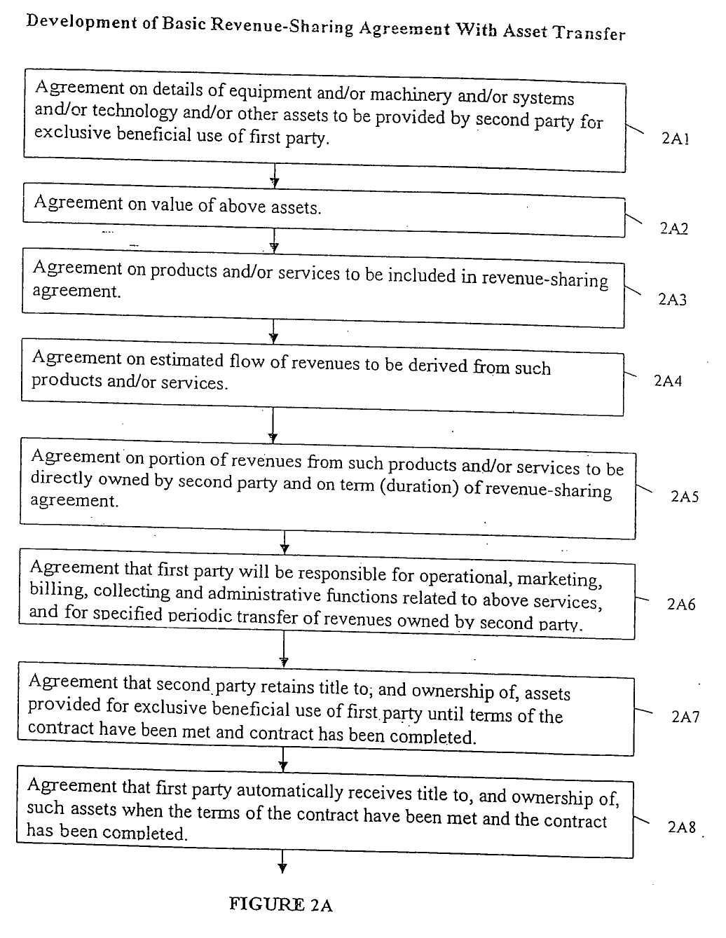

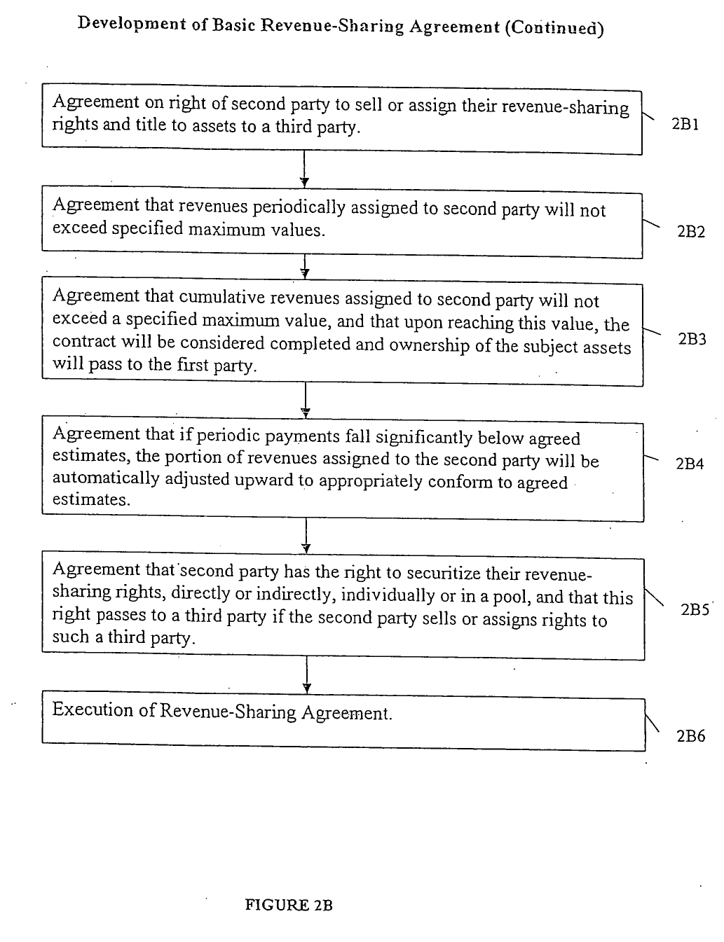

Referring further to FIGS. 2A and 2B, these illustrate steps in developing a revenue-sharing agreement in which a business (first party) receives assets (2A1-2A8) contributed by a second party, and transfers ownership of a specified portion of revenues from a defined source to compensate the second party for such a contribution (2B1-2B6). In this case, the asset-based securities are backed by both ownership of the specified asset and the revenue stream from the revenue-sharing agreement. This particular agreement also includes other provisions, including maximum revenue values to be received by the second party, provisions for transferring the assets to the first party at the expiration of the agreement, adjustments if revenues vary significantly from estimates, and the right of the second party to sell or transfer their rights under the agreement, including the rights to securitize rights under the revenue-sharing agreement.

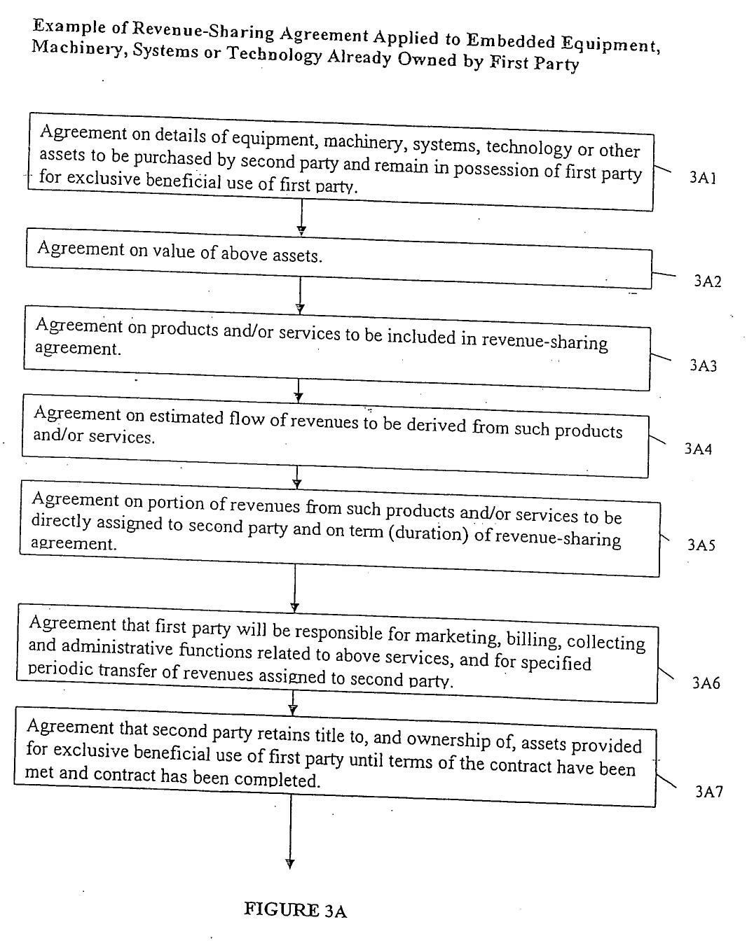

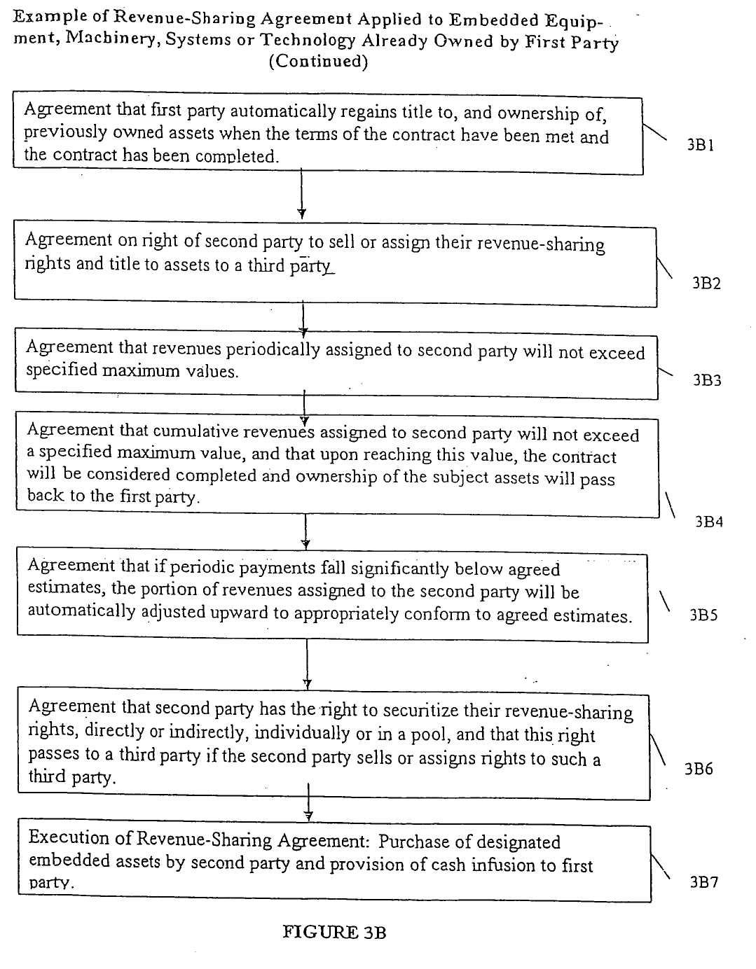

FIGS. 3A and 3B illustrate the process of developing a revenue-sharing agreement (see steps 3A1-3A6) which includes transferring ownership of an asset owned by a business (the first party) to a second party (3A7), provision of a cash infusion to the first party by the second party, and transfer of ownership of a defined portion of specified revenues from the first party to the second party. In this illustration, the second party retains the right to use their revenue rights and the transferred asset as backing for asset-backed securities, and to transfer this right to a third party, see further steps 3B1-3B7.

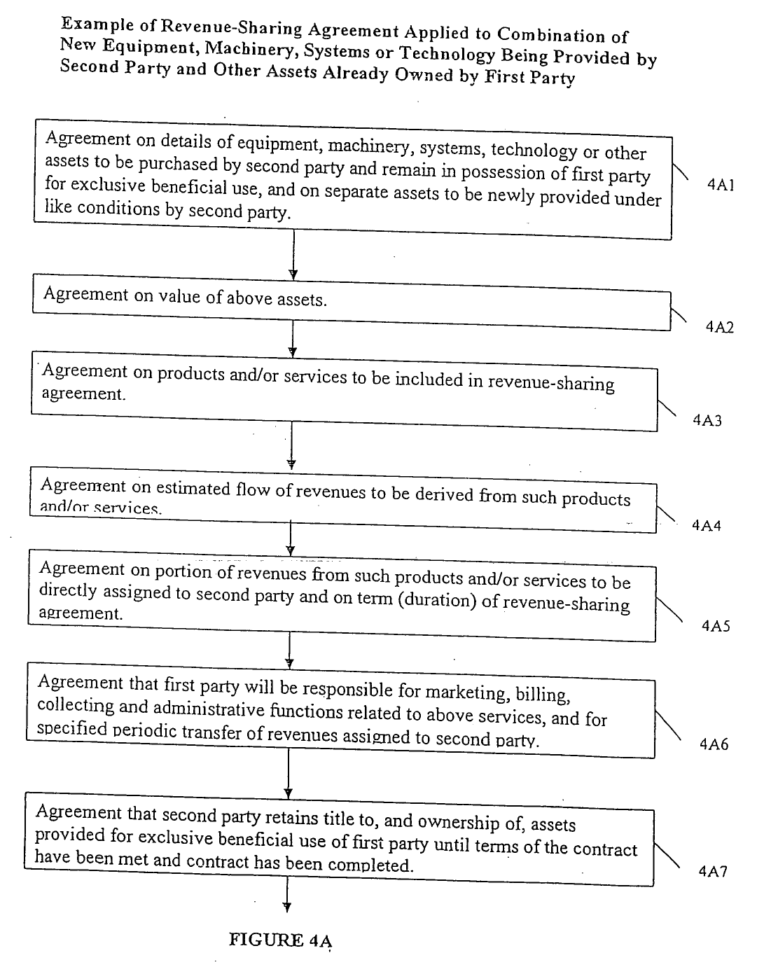

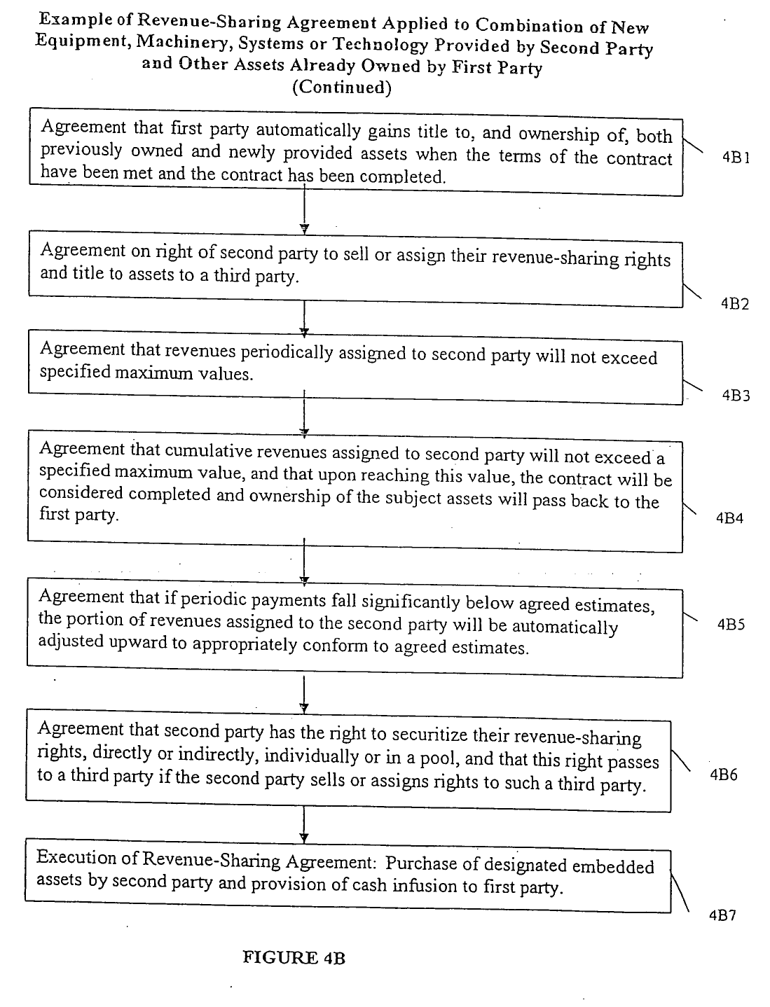

FIGS. 4A and 4B illustrate development of a revenue-sharing agreement (4A1-4A5) which includes a process similar to that shown in FIGS. 3A and 3B, above, but includes the transfer of ownership (4A6-4A7) for both new assets and assets presently owned by the first party. The purpose of this extension of the agreement is to increase the value of assets transferred in order to increase the amount of the related cash infusion, see also steps 4B1-4B7. In addition, the existing assets have an established history of productive use.

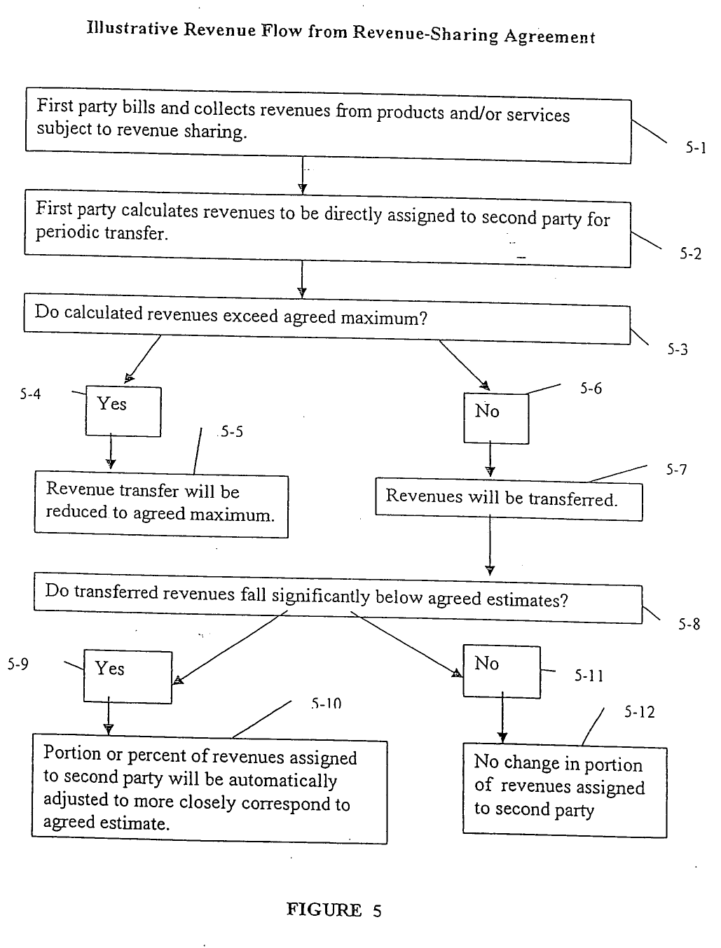

FIG. 5 illustrates how the volume of revenue for which ownership is transferred by the first party under a revenue-sharing agreement may be adjusted for unexpected variations. In this example, provisions in the agreement establish maximums for such revenues, and provide for adjustments if such revenues fall significantly below the estimates on which the agreement was based.

Specifically, the first party bills and collects revenues from products and/or services subject to revenue sharing, at step 5-1. The first party then calculates revenues to be directly assigned to the second party for a periodic transfer, at step 5-2.

At step 5-3, the method queries whether calculated revenues exceed an agreed maximum. If yes (5-4), a revenue transfer will be reduced to an agreed maximum (at 5-5). If no (5-6), revenue of a specified amount will be transferred (5-7) and, successively, the method will query (at 5-8) whether transferred revenues fall significantly below agreed estimates. If yes (at 5-9) the portion or percentage of revenues assigned to the second party will be automatically adjusted to more closely correspond to an agreed estimate (5-10). If no (5-11), no change in a portion of revenues assigned to second party occurs (5-12).

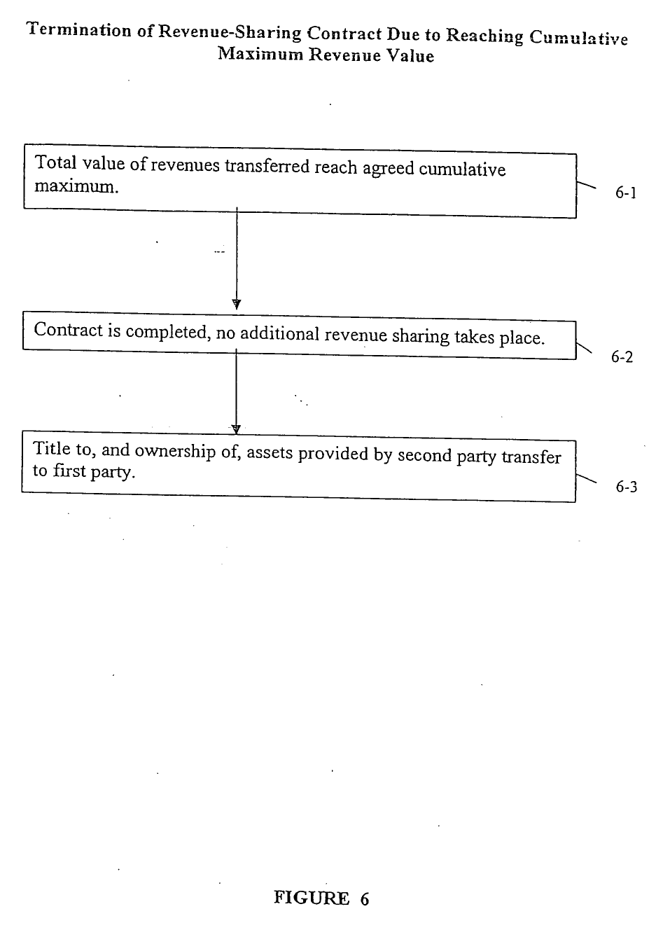

FIG. 6 illustrates termination of the revenue-sharing agreement when a specified maximum revenue value has been received by the second party or successors, including the holders of related asset-backed securities. In this illustration, ownership of the assets provided by the second party and included as backing for securities is transferred to the first party when a specified maximum revenue value has been received by the second party and the agreement has been terminated, both such provisions having been incorporated in the original agreement.

Specifically, step 6-1 indicates a total value of revenues transferred reaching an agreed cumulative maximum. At step 6-2, the contract is completed with no additional revenue sharing taking place. Finally, at step 6-3, title to, and ownership of, the assets provided by the second party transfer occurs to the first party.

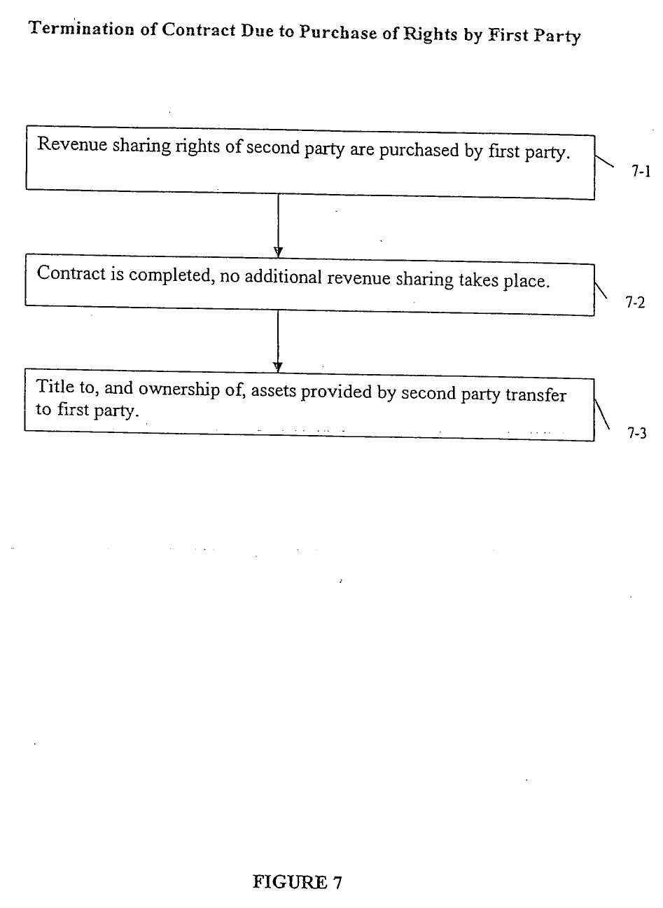

Referring now to FIG. 7, illustrated is a case in which the revenue-sharing agreement includes a provision whereby the first party has the right to terminate the agreement by purchasing the related rights of the second party or successors, and does so. In this example, assets included in the agreement are transferred to the first party in accordance with other provisions of that agreement. According to this protocol, revenue sharing rights of a second party are purchased by a first party (7-1), the contract is then completed, with no additional revenue sharing taking place (7-2) and, finally, title to, and ownership of, assets provided by second party transfer occur to the first party (7-3).

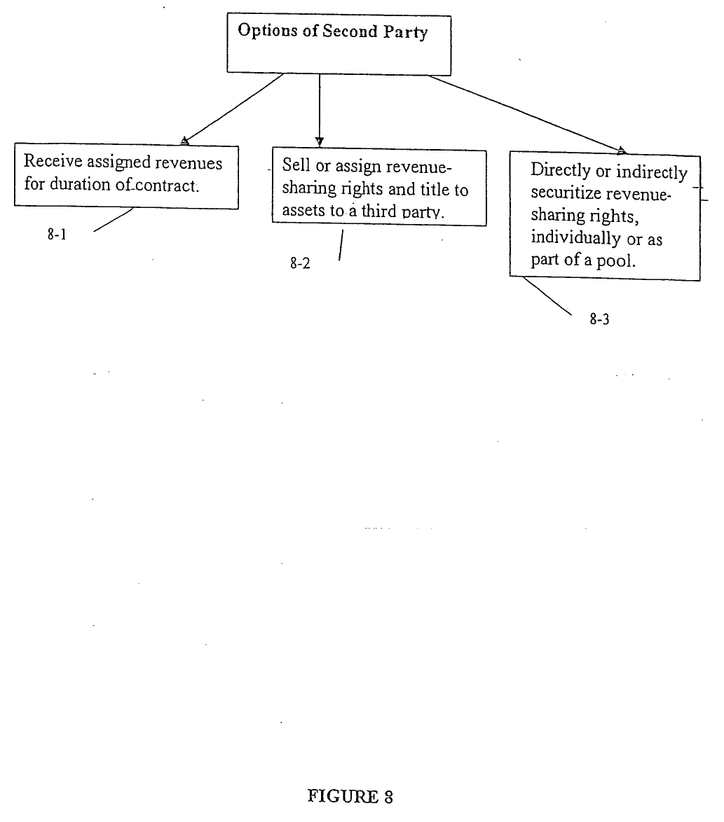

FIG. 8 illustrates a case in which the second party of a revenue-sharing agreement has three options: 1) retain ownership of the revenue-sharing agreement for the duration of the agreement and receive the related stream of revenues (at step 8-1), 2) sell or assign rights under the agreement to a third party, including private placements (step 8-2), or 3) acting directly or through another party, arrange for the development, marketing and sale of asset-backed securities which are based on the agreement (step 8-3).

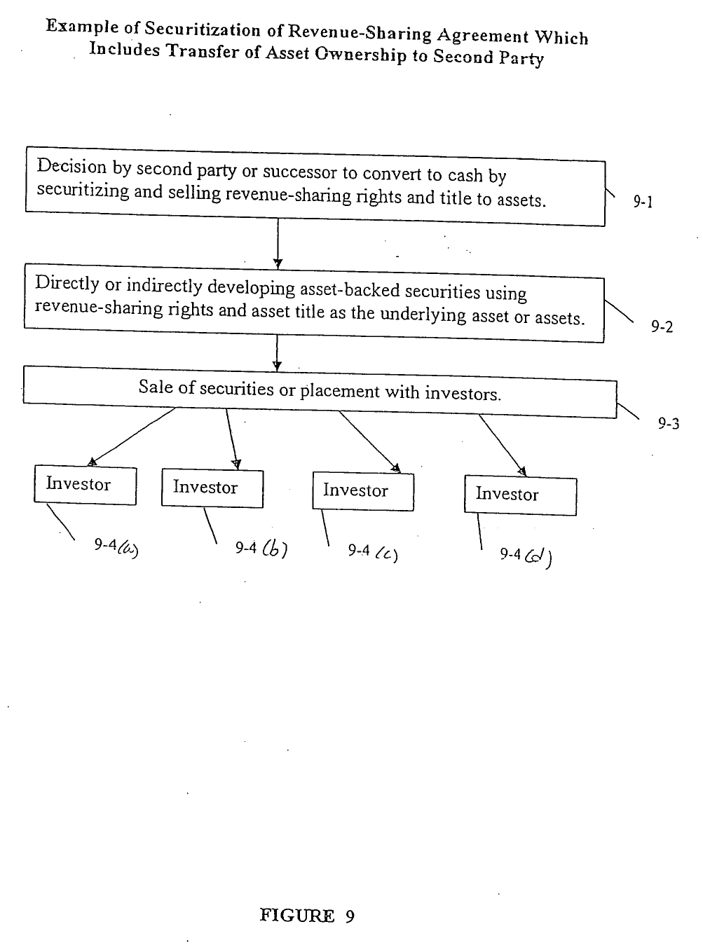

FIG. 9 illustrates a case in which the associated revenue-sharing agreement included transfer to, or ownership of, an asset by the second party, who directly or indirectly liquidated their interest through securitization of their rights under the agreement (see steps 9-1 and 9-2). In other cases, no asset needs to be involved in the process, and the resulting securities rely for backing solely on the revenue-sharing agreement and related stream of revenues (see steps 9-3 and 9-4(a)-(d)). In still other cases, the first party can contract directly with a financial institution for development, marketing and sale of asset-backed securities based solely on a revenue-sharing agreement and related revenue stream. In this last case, the net proceeds from the sale of such securities would flow to the first party as a cash infusion.

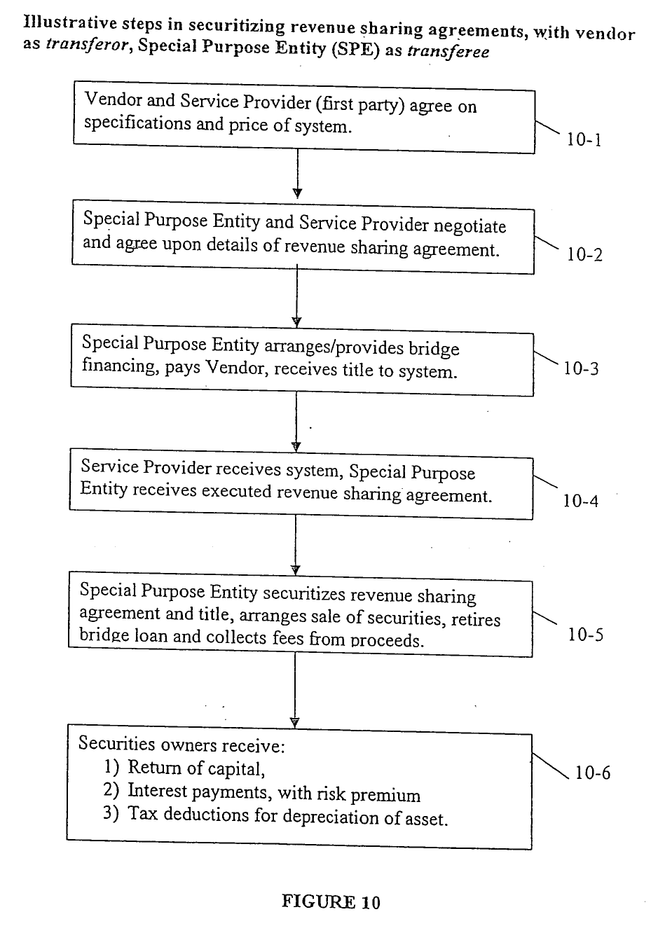

FIG. 10 illustrates steps in securitizing revenue-sharing agreements which are combined with assets provided by a vendor of technology systems, with that system vendor acting as transferor and a Special Purpose Entity (SPE) acting as transferee. In the example shown, ownership of the assets involved pass directly to the SPE, who negotiates a revenue-sharing agreement with the first party, a service provider. The SPE then arranges development and marketing of asset-based securities which include as backing both ownership of the technology system and the revenue-sharing agreement. If revenues meet expectations, the securities owners receive a full return of capital, anticipated interest payments, with a risk premium, and tax deductions for depreciation of related assets.

Specifically, the vendor and service provider (first party) agree on specifications and price of the system (at step 10-1). The special purpose entity (SPE) and service provider (SP) negotiate and agree upon details of the revenue sharing agreement (at 10-2). The SPE then arranges/provides for bridge financing, pays the Vendor, and receives title to the system (at 10-3). At step 10-4, the SP receives the system, the SPE receives the executed revenue sharing agreement. At step 10-5, the SPE then securitizes the revenue sharing agreement and title, arranges sale of securities, retires the bridge loan and collects fees from the proceeds. Finally, at step 10-6, the securities owners receive 1) return of capital, 2) interest payments, with risk premium, and 3) tax deductions for depreciation of the asset(s).

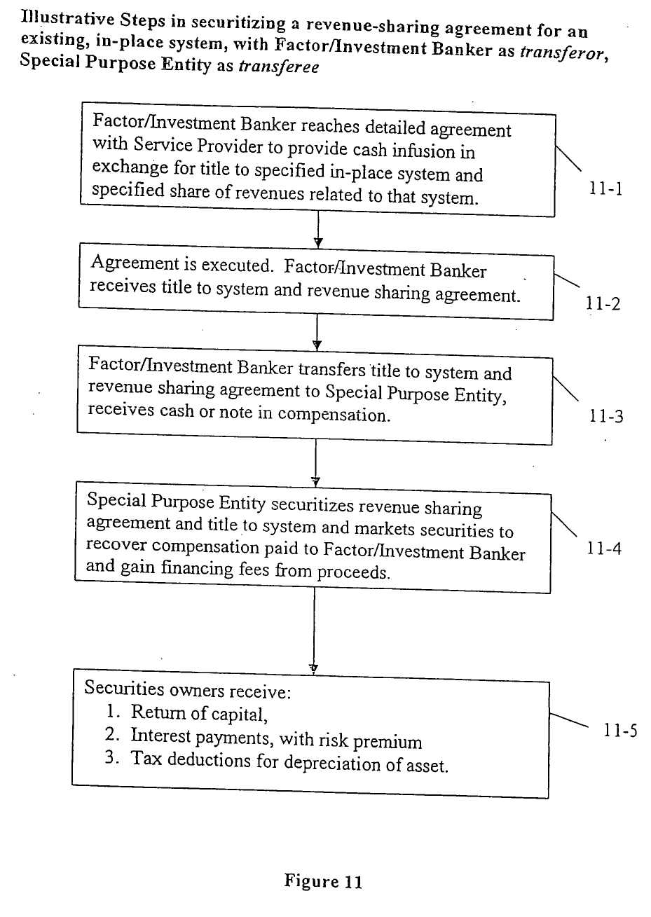

FIG. 11 illustrates steps in securitizing a revenue-sharing agreement for an existing, in-place system, with a factor/investment banker acting as transferor and a Special Purpose Entity (SPE) acting as transferee. In this example, a Factor or Investment Banker acts as an intermediary, negotiating with the first party, a service provider, to provide a specified cash infusion in exchange for title to a technology system of the service provider, plus a revenue-sharing agreement transferring ownership of a specified portion of the related service provider's revenues (see steps 11-1 and 11-2). The Factor/Investment Banker then sells such rights to a SPE (step 11-3), who arranges for development and marketing of asset-backed securities based on the system title and revenue-sharing rights purchased from the Factor/Investment Banker (step 11-4). Because of the involvement of the Factor/Investment Banker as transferor, any transactions involving return of system ownership to the service provider is at “arms length”, and escapes limitations which would otherwise apply. Again, if revenues meet expectations, the securities owners receive a full return of capital, anticipated interest payments, with a risk premium, and tax deductions for depreciation of related assets (step 11-5).

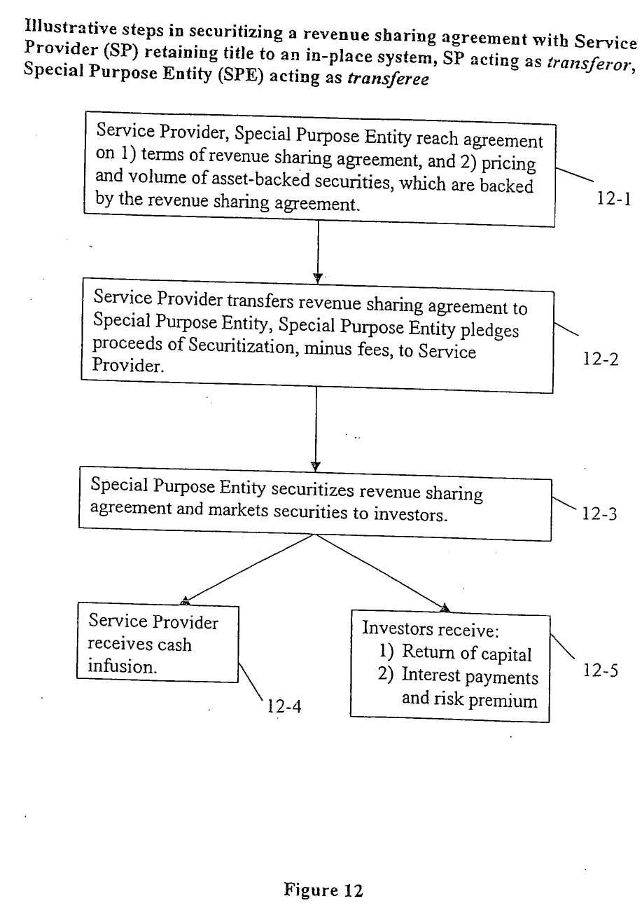

Finally, FIG. 12 illustrates steps in securitizing a revenue-sharing agreement with a first party service provider-retaining title to an in-place system and acting as transferor, and a Special Purpose Entity (SPE) acting as transferee. Accordingly, the SPE reaches agreement on 1) terms of the revenue sharing agreement, and 2) pricing and volume of the asset-backed securities, which are backed by the revenue sharing agreement (step 12-1). The SP transfers the revenue sharing agreement to the SPE, who in turn pledge the proceeds of securitization, minus fees, to the SP (step 12-2). The SPE then securitizes the revenue sharing agreement and markets the securities to investors (step 12-3). At step 12-4, the SP receives a cash infusion and, concurrently, at step 12-5 the investors receive 1) return of capital and 2) interest payments and risk premium.

This case is less complex than the previous two, because the asset-based securities are backed only by a revenue-sharing agreement, with no transfer of a title to an asset. Here, as in prior illustrations, investors receive a full return of capital, interest payments and a risk premium if revenues meet expectations.

Having described my invention, other and additional preferred embodiments will become apparent to those skilled in the art to which it pertains, and without departing from the scope of the appended claims.

1. A method for creating at least one asset-based security, for which a backing therefor comprises the following steps:
providing at least in part one or more revenue-sharing agreements, said agreement specifying at least one continuing source of revenue;
transferring to owners of identified securities at least one of a portion, percent or fractional share of revenues resulting from the agreement, and which may include a specified term or period of duration for said agreement.

2. The method for creating an asset based security as described in claim 1, further comprising the step of providing both a revenue-sharing agreement and at least one defined asset.

3. A method for establishing a revenue sharing agreement comprising the steps of:
a) a first party providing at least one of a product or service, including at least one of all forms of communications, namely internet access, video, and broadband, natural gas, health care, energy, electricity and transportation, as well as processing, manufacturing, refining and distribution activities, including chemicals, metals, minerals, pharmaceuticals, petroleum products, food and beverages;
b) a second party providing at least one of financing or supplying, namely acting as a vendor, broker, factor, investment banker, Special Purpose Entity, intermediary or partner to said first party, the second party providing at least one of enabling, facilitating, expanding, supplementing and enhancing services, products or processes of the first party by providing at least one asset, including but not limited to machinery, equipment, hardware, software, systems or technology to the first party, wherein an effective period of a revenue sharing agreement is specified, said agreement incorporating the following provisions, terms and conditions:
a. the second party retaining title to, and ownership of, the assets provided to the first party for the duration of said revenue sharing agreement, the second party retaining an option to liquidate all or part of his or an interest in the assets and said revenue sharing agreement by securitizing, transferring or selling the assets;
b. the assets being subject to the exclusive use and control of the first party, and may be located or installed on the premises of the first party, and also may be integrated and combined with assets owned by the first party;
c. the first party being responsible for the maintenance and operation of the assets provided by the second party, and for the marketing, administrative, operational, billing and collection functions related to the provision of products or services associated with or derived wholly or in part from the assets provided by the second party, including products or services provided jointly with assets owned by the first party;
d. the second party directly assigning at least one of an agreed defined portion or percent of revenues derived from the services or products, as well as optionally from an otherwise specified group of products and services, the second party having an unqualified, direct and full ownership of such revenues; and
e. an option to vary at least one of a defined portion and percent of such revenues assigned to the second party, or to substitute different products or services subject to revenue sharing;
f. a portion or percent of the revenues defined above being based wholly or in part on the net book or market value of the assets provided by the second party, the net present value of the estimated revenues to be directly assigned to the second party, based on the effective date of the revenue sharing agreement or other agreed date, prevailing and anticipated commercial interest rates, administrative, financing, securitization and miscellaneous costs associated with the revenue sharing contract, including risk factors, the market value of the revenue sharing agreement;
g. the assets to be provided by the second party being clearly specified, together with a stated schedule for their delivery and/or installation, if new;
h. the revenue-producing products/services to be included in the revenue-sharing agreement being specified and estimates of the revenues to be derived from such services at various intervals within the revenue sharing agreement may be stated;
i. a maximum revenue value to be assigned to, and received by, the second party within any given period may be specified;
j. at least one clause/schedule included which provides for adjustments in the portion/percent of revenues directly assigned to the second party when services are added/deleted from the revenue sharing agreement by mutual agreement of the parties and, optionally, if revenues from the services specified above vary significantly from stated estimates;
k. a specified maximum value of revenues assigned to, and received by, the second party during the term of the contract or during a specified period or by a specified date within the term of the contract may be defined, after which maximum is reached, the contract may be terminated without penalty by the first party, or may be terminated automatically; and
l. title to and ownership of the subject assets provided by the second party passing to the first party at the termination of the contract.

4. The method for establishing a revenue sharing agreement as described in claim 3, further comprising the step of providing a backing for asset-based securities to be issued and sold to individual investors or institutions, with such securities providing 1) a return of capital, 2) interest payments, including a risk premium, and 3) tax deductions for depreciation of the underlying assets when the asset title is held by securities owners.

5. The method for establishing a revenue sharing agreement as described in claim 3, further comprising the step of the first party possessing an option to purchase the assets and revenue sharing rights of the second party, by assigning additional revenues or making payments to reach the maximum value, during at least one point in time during the term of the contract.

6. The method for establishing a revenue sharing agreement as described in claim 3, further comprising the step of applying to assets initially owned by the first party, which assets are then purchased by the second party or another entity coincidentally with, or in conjunction with, the execution of the revenue sharing contract, such purchase providing a cash infusion to the first party.

7. The method for establishing a revenue sharing agreement as described in claim 3, further comprising the step of financially restructuring a business entity, by significantly reducing the capital obligations, debt, fixed costs or outstanding stock of such a corporation or business, while providing it with a cash infusion and improved return on investment, said method operating through the selective sale to another entity of assets owned by such a corporation or business, and the coincidental or subsequent related execution of at least one revenue-sharing agreement under which the acquired assets remain in the possession and use of the corporation selling those assets, while that corporation and the acquiring party otherwise agree to revenue sharing under contract provisions and processes.

8. The method for establishing a revenue sharing agreement as described in claim 3, further comprising the step of applying both to assets being newly provided by or through the second party and assets initially owned and operated by the first party and which are purchased by the second party but are retained for beneficial use by the first party under specified terms and conditions.

9. The method for establishing a revenue sharing agreement as described in claim 3, further comprising the step of providing a Special Purpose Entity (SPE) to develop and market asset-backed securities in which rights under the revenue sharing agreement(s) in combination with title to a defined asset or assets provide some or all of the backing for such securities.

10. The method for establishing a revenue sharing agreement as described claim 3, further comprising the step of providing a Special Purpose Entity (SPE) to develop and market asset-backed securities in which rights under revenue sharing agreement(s) and title to a defined asset or assets provide some or all of the backing for such securities, said SPE acting as a transferee in a transaction in which at least one of a vendor, supplier, factor, investment banker, intermediary or other party acts as a transferor of the revenue sharing agreement(s) rights and asset titles prior to securitization.

11. The method for establishing a revenue sharing agreement as described in claim 3, further comprising the step of providing a Special Purpose Entity (SPE) to develop and market asset-backed securities in which rights under revenue sharing agreement(s) and a title to an asset or assets provide backing for such securities, and in which the SPE acts as a transferee in a transaction in which the first party, a service provider or product provider, acts as a transferor of the revenue sharing agreements(s) prior to securitization.

12. The method for establishing a revenue sharing agreement as described in claim 3, further comprising the step providing at least one of an initial Public Offering (IPO) or a supplemental offering, in which investors are offered asset-backed securities including a revenue sharing agreement and selected assets, and which securities include rights to fractional shares of revenues related to that agreement.

13. The method for establishing a revenue sharing agreement as described in claim 3, further comprising the step of providing at least one of an Initial Public Offering (IPO) or supplemental offering, in which investors are offered asset-backed securities, such asset backing including a) a revenue sharing agreement, and b) assets related to the production or derivation of such revenue, and which securities include rights to fractional shares of revenues related to the revenue sharing agreement, and fractional ownership of other assets backing the securities, such securities may also include a limited term of revenue sharing rights and asset ownership, and may also include a stated maximum value of revenues to be paid to or shared with securities owners.

14. A method for establishing a revenue-sharing agreement which include the following: a) a first party, which provides services or products to the public or a selected clientele, and b) a second party, which provides or arranges financing or acts as a broker, factor, investment banker, Special Purpose Entity, intermediary or partner to the first party, wherein an effective period of a revenue-sharing agreement is specified, said method further comprising the steps of:
a. the second party retaining title to the revenue-sharing agreement and, optionally, liquidating at least part of an interest in such agreement by transferring, selling or securitizing the interest;
b. the first party being responsible for at least one of marketing, administrative, operational, billing and collection functions related to the provision of products or services included in the revenue-sharing agreement;
c. the second party directly assigning an agreed defined portion/percent of revenues derived from the services or products referenced above, or from an otherwise specified group or alternative group of products and services, and having an unqualified, direct and full ownership of such revenues;
d. varying, at times during the term of the contract, a defined portion or percent of such revenues assigned to the second party or substituting different products or services subject to revenue sharing;
e. directly assigning to the second party the portion or percent of the revenues defined in (c) based at least in part on the net present value of the estimated revenues, based on the effective date of the revenue-sharing agreement or other agreed date, prevailing and anticipated commercial interest rates, administrative, financing;
f. specifying the revenue-producing products or services to be included in the revenue-sharing agreement and estimating the revenues to be derived from such services at various intervals within the revenue-sharing agreement may be stated;
g. maximizing revenue values to be assigned to, and received by, the second party within any given period may be specified;
h. adjusting a portion or percent of revenues directly assigned to the second party when services are added or deleted from the revenue-sharing agreement by mutual agreement of the parties and, optionally, if revenues from the services specified under in the agreement vary significantly from stated estimates; and
i. establishing a specified maximum value of revenues assigned to, and received by, the second party during the term of the contract, after which the contract may be terminated without penalty by the first party, and optionally may be terminated automatically.

15. The method for establishing a revenue sharing agreement as described in claim 14, further comprising the step of aggregating and pooling revenue sharing rights under one or more agreements to provide the backing for asset-based securities to be issued and sold to individual investors or institutions, such securities providing 1) a return of capital, 2) interest payments, and 3) a risk premium.

16. The method for establishing a revenue sharing agreement as described in claim 14, further comprising the step of the first party having an option to purchase the revenue sharing rights of the second party, by assigning additional revenues or making payments to reach a stated maximum value at one or more times during the term of the agreement.

17. The method for establishing a revenue sharing agreement as described in claim 14, further comprising the step of financially restructuring a business entity by securing a cash infusion to significantly reduce capital obligations, debt, fixed costs or outstanding shares through the execution and sale of the at least one revenue-sharing agreement to thereby secure a cash infusion for such purposes.

18. The method for establishing a revenue sharing agreement as described in claim 14, further comprising the step of creating a Special Purpose Entity (SPE) to develop and market asset-backed securities in which rights under the revenue-sharing agreements provide some or all of the backing for such securities.

19. The method for establishing a revenue sharing agreement as described in claim 14, further comprising the step of creating a Special Purpose Entity (SPE) to develop and market asset-backed securities in which rights under revenue-sharing agreements provide some or all of the backing for such securities, and in which the SPE acts as a transferee in a transaction in which a factor, investment banker, intermediary or other party acts as a transferor of the revenue sharing agreements and rights prior to securitization.

20. The method for establishing a revenue sharing agreement as described in claim 14, further comprising the step of creating an SPE to develop and market asset-backed securities in which rights under revenue-sharing agreements provide the backing for such securities, and in which the SPE acts as a transferee in a transaction in which the first party acts as a transferor of the revenue sharing agreements prior to securitization.

21. The method for establishing a revenue sharing agreement as described in claim 14, further comprising the step of providing at least one of an Initial Public Offering (IPO) or supplemental offering, in which investors are offered asset-backed securities, the securities including rights to fractional shares of revenues related to that agreement, the securities further optionally including a limited term of revenue sharing rights, and may also include a stated maximum value of revenues to be paid to or shared with securities owners.

22. The method for establishing a revenue sharing agreement as described in claim 14, further comprising the step of creating at least one hedging agreement and which include the first party as the producer, provider, extractor or processor of commodities, products or services subject to, or expected to be subject to, significant fluctuations in price, including downward price fluctuations, and the second party, which purchases substantial quantities of such commodities, products or services for use in their operation or wishes to avoid or reduce the risk of upward movements in price levels of such commodities, products or services or others who wish to speculate in, or hedge against such price movements.

23. The method for establishing a revenue sharing agreement as described in claim 14, further comprising the step of providing an alternative to sale and lease-back agreements, in which the first party sells an asset to the second party, receives cash or other compensation from such a sale, and receives operational control of, and responsibility for, such an asset in exchange for executing the revenue-sharing agreement, the new asset owner receiving ownership of a specified portion of the first party's revenues for a defined period, and may transfer or sell such revenue-sharing rights, and which rights may be securitized.

24. The method for establishing a revenue sharing agreement as described in claim 14, further comprising the step of specifying specific products, services, processes or other sources and portions of related revenues to be shared, and therefore provide investors an option of investing directly and exclusively in such specific products, services or processes, including promising technologies and technologies which benefit the environment, including but not limited to coal gasification plants which reduce emissions, nuclear power plants, and hybrid locomotives, cars and trucks, so that investors need not invest in the total earnings and/or structure of the business involved, as reflected in stock offerings.

25. The method for establishing a revenue sharing agreement as described in claim 14, further comprising the step of establishing an asset-backed security which is based wholly or in part on both the revenue-sharing agreement and an asset, wherein the asset is financed by the sale or securitization of the revenue-sharing agreement, thereby reducing the initial and continuing cost of such an asset, as compared to conventional financing, and therefore lowering the cost structure and price floor of the specific products, services or processes derived from or facilitated by such an asset, and permitting a more rapid and profitable marketing of such products, services or processes at less risk.

26. A business method for obtaining efficient and low-cost financing for business-related transactions, including the steps of:
a. establishing an agreement on details of assets to be provided by a second party for the exclusive beneficial use of a first party,
b. establishing an agreed valuation for such assets;
c. developing a revenue-sharing agreement concerning at least one product or service associated with such assets or otherwise provided by the first party;
d. establishing an estimated flow of revenues to be derived from such products or services;
e. agreeing as to the share of said flow of revenues to be owned by said second party for the duration of the revenue sharing agreement;
f. agreeing that the first party will be responsible for operational, marketing, billing, collecting and administrative functions related to said products or services, and for a specified periodic transfer of revenues to the second party,
g. agreeing that the second party will retain title to and ownership of such assets until terms of the revenue sharing agreement have been satisfied and completed, and
h. agreeing that the first party retains exclusive beneficial use of such assets for the term of the revenue sharing agreement, and receives title to and ownership of such assets when terms of the contract have been completed.

27. The method as described in claim 26, further comprising the step of including within said assets at least one component of equipment, machinery, systems or technology.

28. The method as described in claim 26, further comprising the step of the second party selling or assigning revenue sharing rights and asset titles to a third party.

29. The method as described in claim 26, further comprising the step of including the establishment of maximum values for revenues periodically assigned to the second party.

30. The method as described in claim 26, further comprising the step of establishing a maximum cumulative value for revenues assigned to the second party, at which time the terms of the contract will be deemed complete and ownership of and title to the subject assets will pass to the first party.

31. The method as described in claim 26, further comprising the step of assigning a portion of revenues assigned to the second party which will be automatically adjusted to conform to previously agreed estimates.

32. The method as described in claim 26, further comprising the step of at least one of the second party and successor parties having the right to sell or securitize their revenue sharing rights.

33. The method as described in claim 26, further comprising the step of the second party purchasing at least one asset of the first party, thereby providing a cash infusion to the first party, the first party compensating the second party with a revenue sharing agreement, which agreement subsequently may be resold or securitized.
